(19) United States
(12) Patent Application Publication
(10) Pub. No.: US 2020/0283340 A1
(43) Pub. Date: Sep. 10, 2020

(54) ENVIRONMENT-FRIENDLY MICROWAVE DIELECTRIC CERAMIC MATERIAL FOR SMALL NAVIGATION ANTENNA

(71) Applicant: Chenzhou Gongtian Electronic Ceramics Technology Co., Ltd., Chenzhou, Hunan (CN)

(72) Inventors: Gongtian Chen, Chenzhou, Hunan (CN); Juanying Wu, Chenzhou, Hunan (CN); Lianping Xiao, Hongjiang, Hunan (CN)

(21) Appl. No.: 16/062,613

(22) PCT Filed: Jan. 25, 2018
(86) PCT No.: PCT/CN2018/074127

§ 371 Date: Jun. 14, 2018

(30) Foreign Application Priority Data
Mar. 30, 2017 (CN) 201710201632.8

(51) Int. Cl. C04B 35/478; C04B 35/04; C04B 35/626; C04B 35/634; C04B 35/64

(52) U.S. Cl. CPC C04B 35/478; C04B 35/04; C04B 35/6261; C04B 35/63416; C04B 35/64; C04B 2235/442; C04B 2235/6567; C04B 2235/3206; C04B 2235/3284; C04B 2235/3217; C04B 2235/3418; C04B 2235/3239; C04B 2235/604; C04B 2235/3232

(57) ABSTRACT

The present invention relates to an environment-friendly microwave dielectric ceramic material for small navigation antenna, which is applied to the microwave components such as dielectric resonator, filter, oscillator, cellphone antenna and GPS of small navigation antenna transceiving satellite communication system. The main powder ingredients of the raw material of the present invention include: CaCO₃, TiO₂, MgO, ZnO, Al₂O₃ and a micro amount of additives: SiO₂ and V₂O₅. The present invention has low sintering temperature resulting in low power consumption, low dielectric constant, high quality factor and stable resonance frequency temperature characteristic.

### TECHNICAL FIELD

The present invention relates to an environment-friendly microwave dielectric ceramic material for small navigation antenna, which is applied to the microwave components such as dielectric resonator, filter, oscillator, cellphone antenna and GPS of small navigation antenna transceiving satellite communication system.

### BACKGROUND

At present, with the rapid development of China's aerospace technology and satellite communication, there will certainly be multichannel fixed broadcast communication satellites, special broadcast satellites, direct broadcast satellites, mobile broadcast satellites, mobile communication satellites, special GPS satellites and safety navigation satellites. In addition, with the further growth of demand for transmission bandwidth in the data business dominated by IP business, the development and application of small navigation antenna with greater wavelength and wave band have attracted more and more attention. At the same time, the demand for corresponding microwave resonator, filter, oscillator, microwave capacitor and other related microwave components is increased. The frequency bands usually used in satellite communication broadcast are S, L, C and Ku bands, and the microwave dielectric ceramics applied to small navigation antenna is required to have low dielectric constant (15-35), high quality factor, stable resonance frequency temperature characteristic, small size and low price.

CaCO₃.TiO₂.MgO.ZnO.Al₂O₃ is a kind of titanate microwave ceramics with excellent performance, which can obtain appropriate and adjustable dielectric constant, high quality factor and favorable resonance frequency temperature characteristic by doping and other means. In the prior art, CaCO₃.TiO₂.MgO.ZnO.Al₂O₃ is usually prepared by solid state reaction of oxide and additive mixture through the procedures of ingredient weighing, ball milling, pelleting, molding, potting, glue expelling, sintering, metallization and finally ceramic performance test. This method has simple process and is easy to industrialize, and the material obtained has stable performance.

### SUMMARY

The technical problem to be solved in the present invention is to provide an environment-friendly microwave dielectric ceramic material for small navigation antenna, which has low sintering temperature resulting in low power consumption, low dielectric constant, high quality factor and stable resonance frequency temperature characteristic. The present invention is applied to dielectric resonator, filter, oscillator, GPS and safety navigation system of small navigation antenna, and has the advantages of small size and low price.

The technical solution of the problems to be solved in the present invention is as follows:

An environment-friendly microwave dielectric ceramic material for small navigation antenna, with the main powder ingredients of the raw material including: CaCO₃, TiO₂, MgO, ZnO, Al₂O₃ and a micro amount of additives: SiO₂ and V₂O₅, and the content of each ingredient is:

CaCO₃ 24%-30%; TiO₂ 24%-36%;

MgO 23%-33%; ZnO 10%-15%;

Al₂O₃ 1%-6%;

SiO₂ 0.8%-1.4%; V₂O₅ 0.6%-1.7%;

the manufacturing method of the dielectric ceramic material is:

\textcircled{1} weighing CaCO₃, TiO₂, MgO, ZnO, Al₂O₃, SiO₂ and V₂O₅ powders according to the ingredient requirement, putting the powders in the barrel of a ball mill, and conducting ball milling and stirring for 4-6 hours;

\textcircled{2} adding 15% PVA water solution to the milled slurry and stirring for 1-2 hours;

\textcircled{3} molding by dry pressing with a pressure of 500-800 MPa and potting;

\textcircled{4} preserving heat at a temperature of 1200° C.-1280° C. for 2-4 hours, completing glue expelling and sintering at one time, and thus the microwave dielectric ceramic material for small navigation antenna is obtained.

In general, high temperature sintering of titanate will result in the formation of oxygen vacancies V0. These oxygen vacancies with positive charge can adsorb free electrons. In order to compensate for the free electrons and maintain electroneutrality in the structure, the Ti⁴⁺ near the oxygen vacancies will capture excess electrons to generate Ti³⁺ ions. Ti³⁺ is stable in room temperature and high temperature air sintering, whereas the captured electrons and Ti⁴⁺ are relatively loose in structure and are easy to transit to the conduction band and participate in conduction under the action of electric field, and thus resulting in the dielectric property deterioration, resistivity reduction and loss increasing of the system. In addition, it can be seen from the appearance of the sintering sample that the sample has “black core” phenomenon. Our company's scientific and technical personnel discover, after research, that this is because titanium ion is reduced from Ti⁴⁺ to Ti³⁺; high temperature sintering and the reduction of Ti⁴⁺ are important reasons for the increase of damage in titaniferous dielectric ceramics, so we need to find a way to reduce the sintering temperature and restrain the valence change of Ti⁴⁺ at the same time in order to ensure the stability of the electrical properties of ceramics.

The present invention has a small amount of V₂O₅ added as a modifier. The ionic radius of V⁵⁺ is 0.059 nm, which is close to the ionic radius of Ti⁴⁺, 0.068 nm, and the relative difference between the two is less than 15%, which satisfies the size condition of forming substitutional solid solution. V⁵⁺ can exist in TiO² ceramic lattice in two forms, wherein one is in interstitial void and form solid solution; and the other is that V⁵⁺ occupies the position of Ti⁴⁺ and form substitutional solid solution. The ionic radius of V⁵⁺ involved in the present invention is smaller than the ionic radius of Ti⁴⁺, so lattice distortion occurs in ceramics after Ti⁴⁺ is substituted by V⁵⁺, which reduces the diffusion activation energy, promotes the sintering and reduces the sintering temperature.

Exploration and research show that: as the donor doping ions of the present invention, V⁵⁺ can effectively reduce the adverse effects of the acceptor doping ions, and therefore reduce the oxygen vacancies; the balancing action of V⁵⁺ restrains the valence change of Ti⁴⁺, which can reduce the loss and improve the dielectric properties of ceramics.

The present invention has a small amount of SiO₂ added to the ingredients as a sintering additive. Practice shows that: the SiO₂ added, CaO and MgO compose a substance with an eutectic point, which exists in glass phase; the substance exists in liquid phase during sintering to wet the powder particles, achieve the effect of liquid phase sintering and promote the sintering, and thus can reduce the sintering temperature.

The CaCO₃.TiO₂.MgO.ZnO.Al₂O₃ microcrystal powder in the present invention is prepared by solid state reaction of oxide and additive mixture, and a micro amount of additives is added to obtain a microwave dielectric ceramic material with fine and uniform grains, low porosity and excellent performance. Good microwave characteristics can be obtained within the addition range of each additive. In addition, the cost of domestic raw materials is low, which can further enhance the competitiveness relative to foreign microwave ceramics and accelerate the wide application of domestic microwave ceramics.

Compared with the prior art, the present invention has the following characteristics:

1) The composition of the present invention contains no heavy metals such as lead and nickel, i.e. the present invention is a kind of environment-friendly microwave dielectric ceramics which conforms to the requirement of being green, environment-friendly and pollution-free, conforms to the strict requirements of the lead-free standard RHOS and the waste electrical equipment recycling standard WEEE newly issued by the European Community. The present invention can be used in products in high-frequency fields, and the products can be exported to any country in the world;

2) The sintering temperature is reduced to lower than 1270° C. from 1330-1500° C. required by traditional sintering process. The further reduction of the sintering temperature makes the present invention have greater advantage in energy saving;

3) There is big improvement in performance: the formulation of the traditional technology in small navigation antenna has a dielectric constant of 70-90, a Q-value of only 1000-1500, and a resonance frequency temperature coefficient exceeding ±30 PPm, whereas the formulation of the present invention has a dielectric constant of 15-35, a Q-value of greater than 4000, and a resonance frequency temperature coefficient within ±10 PPm;

4) The present invention can be widely used in modern communication industries such as mobile communication, satellite communication, Global Positioning System (GPS), Bluetooth technology and Wireless Local Area Network (WLAN) as the key and core material in the electronic components such as environment-friendly microwave resonator, filter and oscillator of small navigation antenna, and has great industrial application value.

### BRIEF DESCRIPTION OF THE DRAWINGS

FIG. 1 is a diagram showing the relationship between sintering temperature and quality factor Q-value.

FIG. 2 is a characteristic curve showing the change of resonance frequency along with temperature change.

FIG. 3 is a curve showing the relationship between quality factor Q-value and resonance frequency.

### DETAILED DESCRIPTION

The present invention is realized through the following technical solution.

An environment-friendly microwave dielectric ceramic material for small navigation antenna, with the main powder ingredients of the raw material including: CaCO₃, TiO₂, MgO, ZnO, Al₂O₃ and a micro amount of additives: SiO₂ and V₂O₅. Table 1 shows the data of each embodiment, and Table 2 shows the performance of each embodiment.

TABLE 1

| | | | | | | | | | Glue Expelling | Glue Expelling |
|---|---|---|---|---|---|---|---|---|---|---|
| | | | | | | | | Stirring and | and Sintering | and Sintering |
| Embodiment | CaCO₃ | TiO₂ | MgO | ZnO | Al₂O₃ | SiO₂ | V₂O₅ | Milling Time | Temperature | Time |
| No. | (wt %) | (wt %) | (wt %) | (wt %) | (wt %) | (wt %) | (wt %) | (H) | (° C.) | (H) |
| 1 | 24 | 30 | 28.5 | 10 | 6 | 1.2 | 0.6 | 4 | 1200 | 3 |
| 2 | 26 | 27 | 28 | 12 | 5 | 0.8 | 1.2 | 4 | 1220 | 3.5 |
| 3 | 30 | 24 | 33 | 10 | 1 | 0.8 | 1.2 | 4 | 1240 | 4 |
| 4 | 25 | 36 | 23 | 10.5 | 3 | 1 | 1.5 | 4 | 1260 | 4 |
| 5 | 24 | 30 | 26 | 13 | 4 | 1.3 | 1.7 | 4 | 1280 | 4 |
| 6 | 28 | 32 | 25 | 10 | 2 | 1.4 | 1.6 | 4 | 1270 | 2 |
| 7 | 24 | 27.5 | 27 | 15 | 4 | 1.2 | 1.3 | 4 | 1250 | 2.5 |
| 8 | 25 | 28 | 27.5 | 12 | 6 | 0 | 1.5 | 4 | 1310 | 3 |
| 9 | 23 | 28 | 30 | 14.5 | 4 | 0.5 | 0 | 4 | 1320 | 3 |
| 10 | 27 | 30 | 31 | 10 | 2 | 0 | 0 | 4 | 1360 | 3 |

TABLE 2

| | Gongtian | | | | | | |
|---|---|---|---|---|---|---|---|
| | Electronic | | | | | Quality | |
| | Ceramics | Outer | | Dielectric | Resonance | Factor | Temperature |
| Embodiment | Technology | Diameter | Thickness | Constant | Frequency | Q-Value | Characteristic τ r |
| No. | Co., Ltd. Type | (mm) | (mm) | ∈r | (MHz) | (GHz) | (ppm/° C.) |
| 1 | DRT1575 | 24.95 | 4.0.5 | 21.5 | 1575 | 4802 | 3 |
| 2 | DRT1575 | 24.92 | 4.05 | 21.8 | 1574 | 4921 | 3.2 |
| 3 | DRT1575 | 24.95 | 4.06 | 21.8 | 1573 | 4925 | 2.8 |
| 4 | DRT1575 | 24.96 | 4.04 | 21.6 | 1573 | 4960 | 2.5 |
| 5 | DRT1575 | 24.91 | 4.05 | 21.8 | 1572 | 4943 | 2.2 |
| 6 | DRT1575 | 24.93 | 4.05 | 21.6 | 1576 | 4834 | 2.2 |
| 7 | DRT1575 | 24.95 | 4.02 | 21.5 | 1577 | 4901 | 2.3 |
| 8 | DRT1575 | 25.12 | 4.02 | 18.9 | 1575 | 2206 | 5 |
| 9 | DRT1575 | 25.5 | 4.03 | 18.5 | 1574 | 3143 | 6 |
| 10 | DRT1575 | 25.8 | 4.06 | 16 | 1574 | 1809 | 8 |

### CONCLUSION

It can be seen from comparison items 8, 9 and 10 of Table 1 that the sintering temperature will significantly increase without the addition of SiO₂ and V₂O₅;

It can be seen from comparison items 8, 9 and 10 of Table 2 that the dielectric constant and the quality factor will decrease without the addition of SiO₂ and V₂O₅;

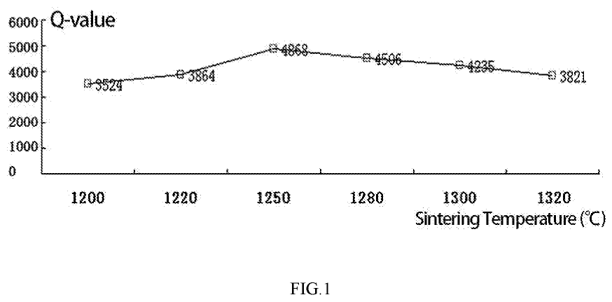

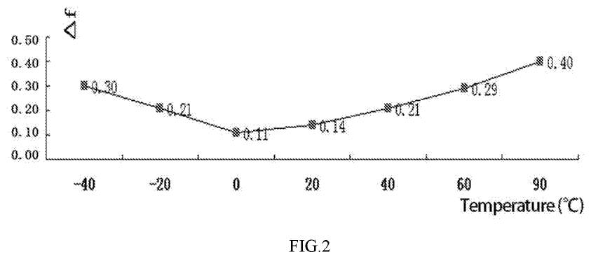

FIGS. 1-2 summarize the change tendency of formulation and performance, which facilitates the adjustment of formulation to obtain the microwave dielectric ceramics of required performance;

The quality factor Q-value of resonance frequency in FIG. 1 will increase with the frequency, and will decrease when the temperature reaches 1300° C.;

The characteristic tendency chart of the relationship between temperature and resonance frequency in FIG. 2 shows that the resonance frequency varies when the temperature is between −40° C. and +80° C., and the medium frequency offset for the resonance frequency of 1.575 GHz is within 5 MHz (Tf=5 ppm/° C.), so the frequency stability is good;

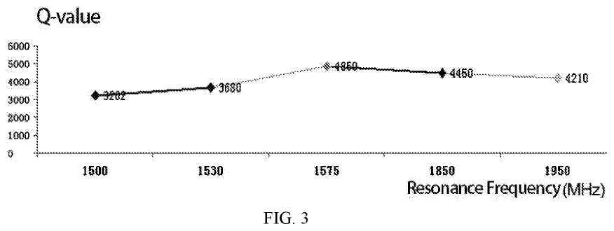

FIG. 3 is a curve showing the relationship between quality factor Q-value and resonance frequency. The Q-value will increase with the frequency, will be the largest when the frequency reaches 1575 MHz, and will decrease when the frequency further increases, which indicates that the dielectric ceramics of this formulation is suitable for resonance circuit with a resonance frequency of 1575 MHz.

What is claimed is:

1. An environment-friendly microwave dielectric ceramic material for small navigation antenna, with the main powder ingredients of the raw material including: CaCO₃, TiO₂, MgO, ZnO, Al₂O₃ and a micro amount of additives; the dielectric ceramic material is characterized in that: the micro amount of additives are SiO₂ and V₂O₅, and the content of each ingredient is:
CaCO₃ 24%-30%; TiO₂ 24%-36%;
MgO 23%-33%; ZnO 10%-15%;
Al₂O₃ 1%-6%;
SiO₂ 0.8%-1.4%; V₂O₅ 0.6%-1.7%;
the manufacturing method of the dielectric ceramic material is:
\textcircled{1} weighing CaCO₃, TiO₂, MgO, ZnO, Al₂O₃, SiO₂ and V₂O₅ powders according to the ingredient requirement, putting the powders in the barrel of a ball mill, and conducting ball milling and stirring for 4-6 hours;
\textcircled{2} adding 15% PVA water solution to the milled slurry and stirring for 1-2 hours;
\textcircled{3} molding by dry pressing with a pressure of 500-800 MPa and potting;
\textcircled{4} preserving heat at a temperature of 1200° C.-1280° C. for 2-4 hours, completing glue expelling and sintering at one time, and thus the microwave dielectric ceramic material for small navigation antenna is obtained.
